(19) United States
(12) Patent Application Publication
(10) Pub. No.: US 2013/0062521 A1
(43) Pub. Date: Mar. 14, 2013

(54) ELECTRONIC DEVICE AND METHOD OF PRODUCTION OF INFRARED LIGHT SHIELD PLATE MOUNTED IN ELECTRONIC DEVICE

(71) Applicant: Ryusuke HIRAYAMA, Kawasaki (JP)

(72) Inventor: Ryusuke HIRAYAMA, Kawasaki (JP)

(73) Assignee: FUJITSU MOBILE COMMUNICATIONS LIMITED, Kawasaki-shi (JP)

(21) Appl. No.: 13/598,323

(22) Filed: Aug. 29, 2012

(30) Foreign Application Priority Data
Sep. 14, 2011 (JP) 2011-200845

(51) Int. Cl. G01J 5/10; B05D 5/06

(52) U.S. Cl. 250/338.1; 427/58

(57) ABSTRACT

An electronic device which is provided with a liquid crystal display device which includes an edge light type of light source, a light guide plate, and a liquid crystal panel, for detecting proximity of an object to the liquid crystal panel by an optical type object detector comprising two infrared light LEDs which are arranged aligned with the light source and which emit infrared light inside the light guide plate, an infrared light shield plate which blocks infrared light which strikes the liquid crystal panel from the light guide plate except for at predetermined regions, infrared light LEDs which are arranged at positions separated from the predetermined regions and emit infrared light in a direction vertical to the liquid crystal panel, a proximity sensor which detects reflection of infrared light by an object, and a control device, so that the housing thereof does not become larger in size.

### CROSS-REFERENCE TO RELATED APPLICATION

This application is a continuation application based upon and claiming priority of Japanese Patent Application No. 2011-200845, filed on Sep. 14, 2011, the contents being incorporated herein by reference.

### FIELD

The present application relates to an electronic device and a method of production of an infrared light shield plate which is mounted in an electronic device.

### BACKGROUND

In a mobile phone or other electronic device, as the input device, in place of a keyboard, providing an image display with a touch panel and viewing the image displayed on the image display while touching the touch panel to operate it and input information is becoming popular. Further, there is a non-contact information input device which enables operation and input information without touching the image display by just moving the hand or an object in front of the screen of the image display.

One of such non-contact information input devices is described in Japanese Laid-Open Patent Publication No. 2011-39958. In the non-contact information input device which is described in Japanese Laid-Open Patent Publication No. 2011-39958, light from light sources which are arranged at the four corners of a light guide plate enter the light guide plate. A light scattering structure at the back surface of the light guide plate deflects the light to emit it upward from the light emission surface. Light which is reflected by the object concerned is detected by photodetectors so as to detect the two-dimensional position of the object concerned.

Further, in recent years, smartphones have been becoming popular. Smartphones are provided with one-piece housings with no keyboards. Such smartphones generally have touch panels built in image displays which are provided at the entire front surfaces of the housings. Operations and input of information are performed using the touch panels. Such smartphones mount various types of sensors. The sensors detect necessary situations in accordance with the usage conditions of the smartphones and improve the user friendliness of the smartphones.

A proximity sensor is one of the sensors which is mounted in a smartphone. Together with infrared light emitting diodes which emit infrared light (hereinafter sometimes referred to as “infrared light LEDs” or “infrared light emitting devices”), this forms an optical type object detector. An optical type object detector detects an object in proximity to the smartphone. The proximity sensor in a smartphone is for example used to prevent the touch panel which is provided at the image display of the smartphone at the time of conversation from being touched by part of the body of the user and causing erroneous operation of the smartphone. That is, the proximity sensor is used to detect proximity of the ear or other object to the receiver of the smartphone at the time of conversation and turn off input to the touch panel so as to prevent erroneous operation. Further, when the proximity sensor detects proximity of the ear or another object to the receiver, the backlight of the image display is also turned off, so the power consumption of the smartphone can be kept down.

An optical type of object detector which is provided with infrared light LEDs and a proximity sensor enables input to an electronic device even without direct contact of the image display, so enables operation of an electronic device even when the electronic device does not mount a touch panel. Such an optical type object detector for example may be mounted in an electronic book reader etc. In the electronic book reader, if moving the hand in front of the display screen of the image display from the left to the right, it is possible to turn the pages of the book which is displayed on the display screen. The letters can be enlarged by the operation of opening the distance between the thumb and forefinger and the letters can be reduced by the operation of closing it.

One example of the comparative art of an electronic device which is provided with an optical type object detector will be explained using FIG. 1A and FIG. 1B. FIG. 1A is a plan view of an electronic device 5 which is provided with infrared light LEDs 1, 2, 3 and a proximity sensor 4. This electronic device 5 is, for example, a smartphone. At the center, there is an image display 6 which is lit by an edge light type of backlight. This image display 6 has a touch panel built into it. The infrared light LEDs 1, 2, and 3, as depicted in FIG. 1B, emit infrared light IR in a direction vertical to the display screen of the image display 6. Around the image display 6 of the electronic device 5, in particular at the housing rim 7 parts in the long direction, infrared light LEDs 1 and 3 are arranged. Around the image display 6 of the electronic device, in particular at the housing rim 7 parts in the short direction, the infrared light LED 2 and the proximity sensor 4 are arranged.

Further, if the infrared light which is emitted from the plurality of infrared light LEDs 1, 2, and 3 toward the front from the display screen of the image display 6 is reflected by a hand or other object in the front from the display screen, the reflected light is input to the proximity sensor 4 and the presence of an object is detected. For example, if moving the hand in front of the display screen of the image display 6 of the electronic device 5, the time difference of the reflected light of the infrared light which is emitted from the infrared light LEDs 1, 2, and 3 is detected by the proximity sensor 4 whereby the direction of movement of the hand is detected. The displayed content of the image display 6 is changed in accordance with the patterns of movement of the hand which are stored in advance in the electronic device 5.

However, the optical type object detector which is depicted in FIG. 1A and FIG. 1B includes an infrared light sensor which is mounted around the image display of the electronic device, in particular at the housing rim in the long direction. For this reason, there was the issue that in the optical type object detector which is depicted in FIG. 1A and FIG. 1B, the housing of the electronic device became larger in the width direction and this obstructed realization of smaller size and thickness of the electronic device. For example, in the information input device which is disclosed in Japanese Laid-Open Patent Publication No. 2011-39958, the light sources of the position detection light are arranged around the light guide plate, so the size of the body of the electronic device provided with the information input device became larger.

### SUMMARY

In one aspect, the present application has as its object the provision of an electronic device not becoming larger in size of the housing and a method of production of an infrared light shield plate mounted in an electronic device.

According to one embodiment, the electronic device of the present application is an electronic device which is provided with a liquid crystal display device having a light source, a light guide plate, and a liquid crystal panel and which optically detects proximity of an object to the liquid crystal display device, the electronic device provided with at least one infrared light emitting device which is arranged along an end of the light guide plate aligned with the light source and from which infrared light is emitted from a display screen of the liquid crystal display device, an infrared light shield plate which is interposed between the light guide plate and the liquid crystal display panel and which is provided with infrared light pass regions which pass infrared light which is emitted from the at least one infrared light emitting device, an infrared light emitting device which is arranged at a position separated from the infrared light pass regions and which emits infrared light in a direction vertical to the display screen, a proximity sensor which detects light of infrared light reflected by the object, and a control device which detects proximity of the object to the display screen by a detection signal of reflected light of the infrared light from the proximity sensor.

Further, according to another embodiment, the method of production of an infrared light shield plate mounted in an electronic device of the present application is a method comprising preparing a first pass filter which passes infrared light and visible light, masking regions through which infrared light passes in the first pass filter, and vapor depositing a second filter which blocks the passage of infrared light through the first pass filter.

### BRIEF DESCRIPTION OF DRAWINGS

FIG. 1A is a plan view of an electronic device with is provided with infrared light LEDs and a proximity sensor of the comparative art.

FIG. 1B is a side view which illustrates a direction of emission of infrared light from the electronic device which is illustrated in FIG. 1A.

FIG. 2A is a perspective view which illustrates the appearance of one example of the electronic device of the present application.

FIG. 2B is a disassembled perspective view which illustrates the configuration of the inside of the electronic device which is illustrated in FIG. 2A.

FIG. 3 is an assembled perspective view which illustrates the configuration of the liquid crystal display device which is illustrated in FIG. 2B.

FIG. 4A is a block circuit diagram which illustrates the configuration of an optical type object detector of one embodiment of the present application.

FIG. 4B is a partial view which illustrates another example of the arrangement of infrared light LEDs in FIG. 4A.

FIG. 5A is a perspective view which illustrates the configuration after assembly of the liquid crystal display device which is illustrated in FIG. 2B and the cross-sectional position which is illustrated by the line D-D.

FIG. 5B is a perspective view which illustrates the configuration after assembly of the liquid crystal display device which is illustrated in FIG. 2B and the cross-sectional position which is illustrated by the line E-E.

FIG. 6A to FIG. 6C are process diagrams which illustrate the method of production of the infrared light shield plate which is illustrated in FIG. 3.

FIG. 7A is a perspective view which illustrates the appearance of an infrared light LED which is used in the liquid crystal display device of the present application.

FIG. 7B is a longitudinal cross-sectional view along the line B-B of the infrared light LED which is illustrated in FIG. 7A.

FIG. 7C is a perspective view which illustrates the appearance of a one-piece sensor which is used in the liquid crystal display device of the present application.

FIG. 7D is a cross-sectional view along the line D-D which is illustrated in FIG. 5A which illustrates the path of light emitted from backlight use LEDs in the liquid crystal display device.

FIG. 7E is a cross-sectional view along the line E-E which is illustrated in FIG. 5B which illustrates the path of light emitted from infrared light LEDs in the liquid crystal display device.

FIG. 8 is a plan view of a smartphone as an electronic device to which an optical type object detector is mounted according to the present application.

FIG. 9 is a perspective view which explains detection of an object in proximity in the smartphone which is illustrated in FIG. 8.

FIG. 10 is a block circuit diagram which illustrates the configuration of another embodiment of the optical type object detector of the present application.

### DESCRIPTION OF EMBODIMENTS

Below, embodiments of the present invention will be explained in detail using the attached drawings and based on specific examples. In the embodiments which are explained below, as an example of the electronic device, a feature phone, which generally indicates a mobile phone, or a smartphone, which is higher in performance than a mobile phone, will be explained. This is because among feature phones and smartphones, there are ones which may use infrared light LEDs and proximity sensors to detect the proximity of an object.

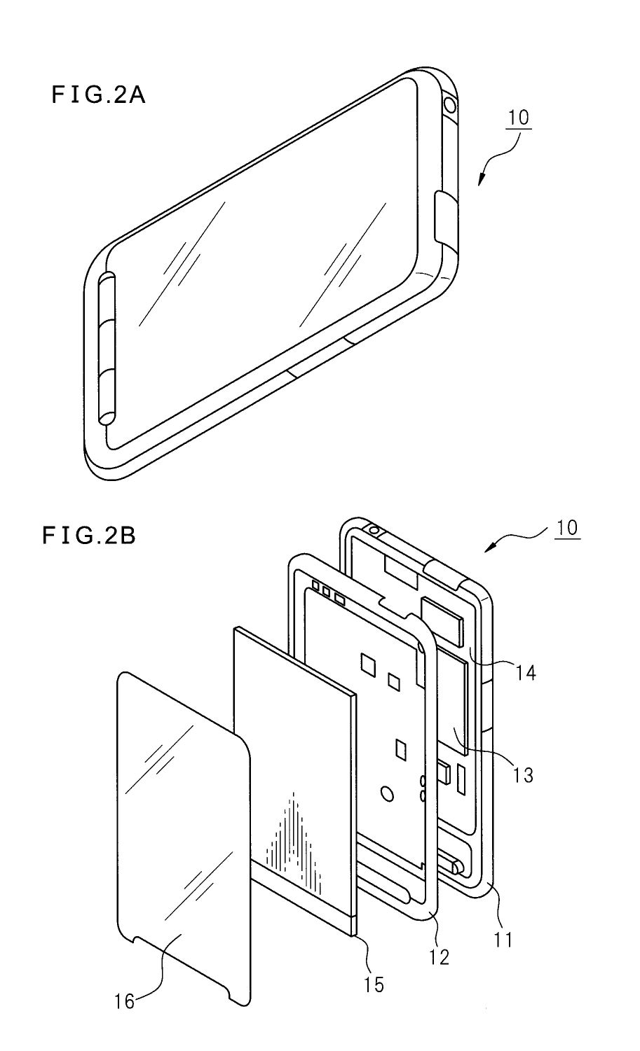

The present application eliminates the problems in an electronic device which is provided with a liquid crystal display device which mounts an optical type object detector and has a conventional edge light type of backlight. That is, it is designed to realize smaller size of an electronic device even if the electronic device mounts an optical type object detector. Further, the present application is designed to obtain freedom of arrangement of the infrared light LEDs and proximity sensor. FIG. 2A illustrates an electronic device of the present application constituted by a smartphone 10. The smartphone 10, as illustrated in FIG. 2B, is provided with a bottom housing 11 which carries a circuit board 14 on which various electronic components 13 are mounted and a top housing 12 which carries a liquid crystal display device 15 and surface glass 16.

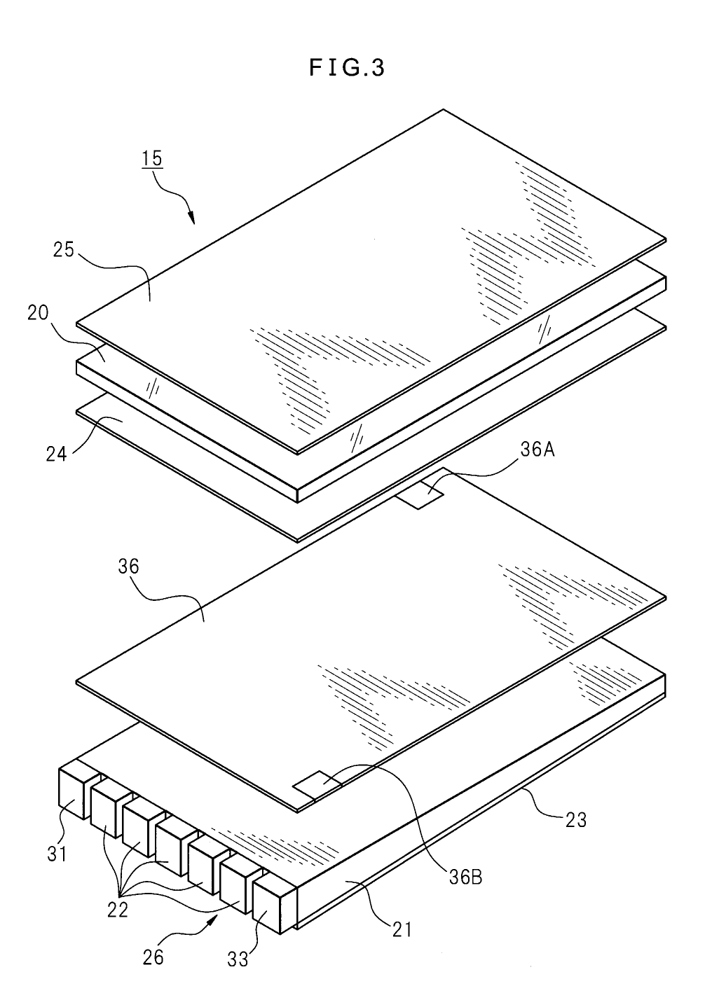

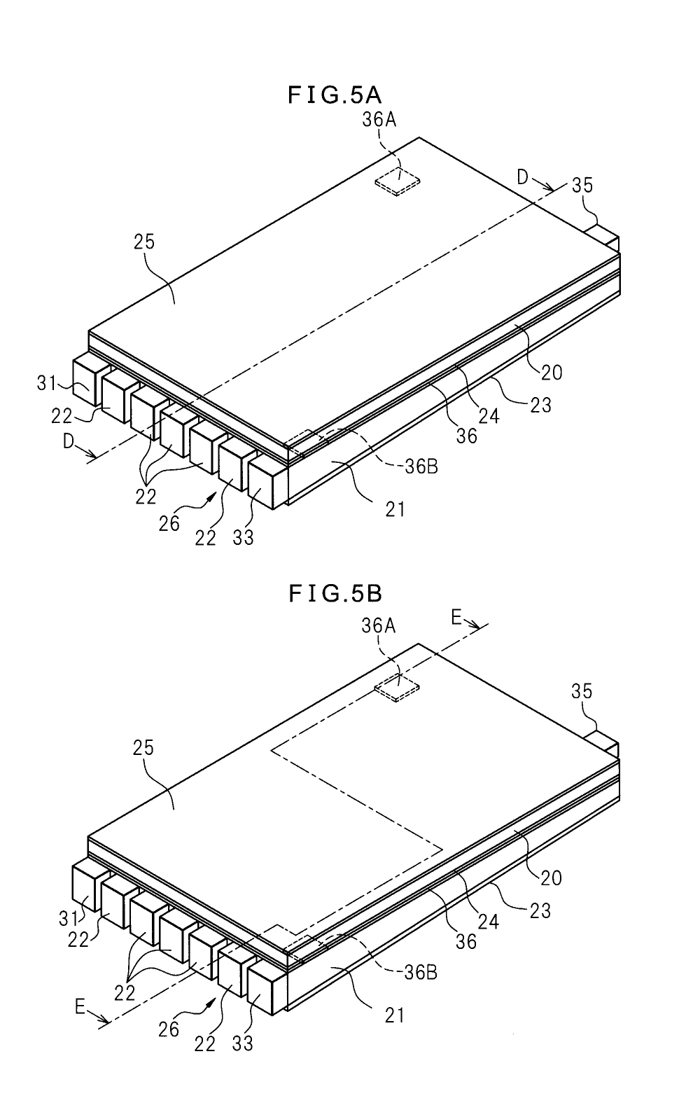

FIG. 3 is an assembled perspective view which illustrates the configuration of the liquid crystal display device 15 which is illustrated in FIG. 2B. One example of an image display, that is, the liquid crystal display device 15, as illustrated in FIG. 3, is provided with a liquid crystal panel 20, light guide plate 21, backlight use LEDs 22, reflecting plate 23, backlight use light deflection plate 24, and color filter 25. The liquid crystal display device of the present application 15 additionally has an infrared light shield plate 36. The state after assembly of the liquid crystal display device 15 which is illustrated in FIG. 3 is illustrated in FIGS. 5A, 5B. A plurality of the backlight use LEDs 22 are aligned at a side face of the light guide plate 21 and form an LED array 26. That is, backlight use LEDs 22 are arranged aligned at a side face of the liquid crystal display device 15 in the short direction.

The light which is emitted from the LED array 26 enters the inside of the light guide plate 21 from the side face. The top surface of the light guide plate 21 is a flat smooth surface. On the other hand, the bottom surface of the light guide plate 21 is flat and smooth, but gradually slants toward the top surface the further from the LED array 26. The slanted bottom surface is provided with the reflecting plate 23 which reflects light which enters it from the LED array 26 to the direction of the top surface. The reflecting plate 23 is printed on the surface at the light guide plate 21 side with a not illustrated dot pattern. Light which enters it from the side face and advances while being reflected in the light guide plate 21 is reflected upward when striking the dot pattern, reaches the liquid crystal panel 20, then illuminates the liquid crystal panel 20. The functions of the backlight use deflection panel 24 and the color filter 25 are known, so explanations will be omitted.

The infrared light shield plate 36 is arranged over the top surface side of the light guide plate 21 of the liquid crystal display device 15 and is provided with infrared light pass regions 36A, 36B at predetermined locations in the direction of emission of infrared light from the infrared light LEDs 31, 33. At locations other than the infrared light pass regions 36A, 36B, the infrared light cannot pass through the infrared light shield plate 36. That is, the liquid crystal display device 15 in the present application is formed by interposing the infrared light shield plate 36 between the light guide plate 21 and the backlight use deflection plate 24 which are illustrated in FIG. 3 and arranging infrared light LEDs 31, 33 at the two ends of the LED array 26.

The infrared light LEDs 31, 33 need not be arranged at the two ends of the LED array 26 and may also be arranged in the spaces between the backlight use LEDs 22 forming the LED array 26. The arrangement of the infrared light LEDs 31, 33 will be explained in detail later.

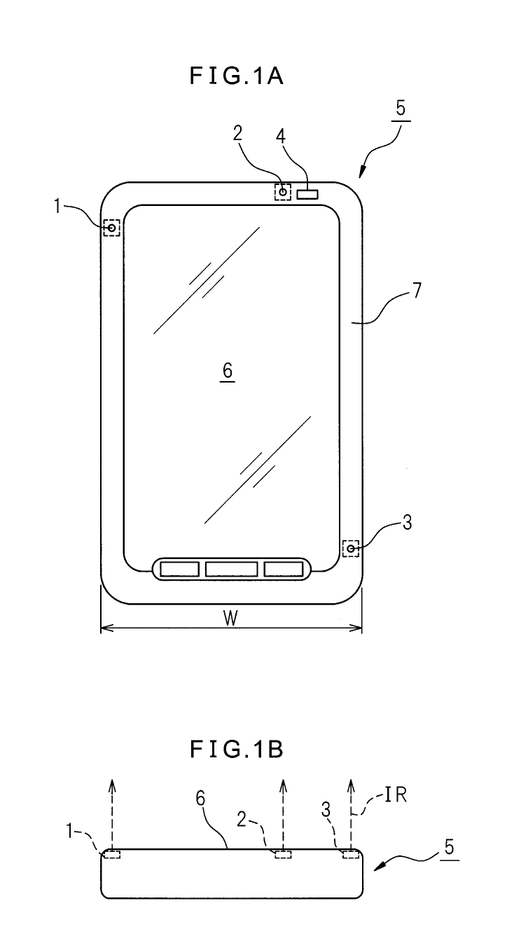

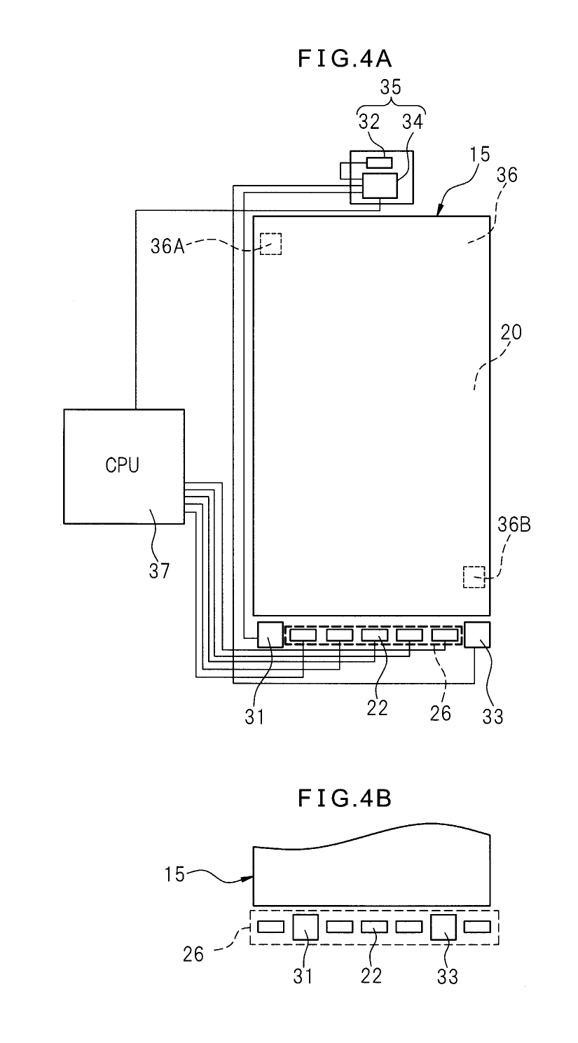

FIG. 4A illustrates an optical type object detector of an embodiment of the present application. Note that in the following explanation of the optical type object detector of the present application, members the same as members which were explained from FIG. 1A to FIG. 3 will be assigned the same reference notations for the explanation. The optical type object detector of the present application is provided with infrared light LEDs 31 to 33, a proximity sensor 34, infrared light shield plate 36, and central processing unit (CPU) 37. The above infrared light LEDs will sometimes be called “infrared light emitting devices”.

The infrared light LEDs 31, 33 are arranged at the light guide plate 21 of the liquid crystal display device 15 at the same short direction end as the LED array 26. In this embodiment, they are arranged at the two ends of the LED array 26. The length of the total length of the LED array 26 plus the lengths of the infrared light LEDs 31, 33 is within the horizontal width of the liquid crystal display device 15. The direction of emission of the infrared light which is emitted from the infrared light LEDs 31, 33 is the same direction as the direction of emission of illuminating light from the LED array 26. The infrared light enters the light guide plate 21. Note that, by providing the infrared light LEDs 31, 33 at the two ends of the LED array 26, when the illuminating light becomes weaker at the two ends of the LED array 26, the luminances of the backlight use LEDs 22 at the two ends of the LED array 26 are made higher than the luminances of the other backlight use LEDs 22.

An infrared light LED 32 is arranged at the end of the light guide plate 21 at the opposite side to the end of the light guide plate 21 at which the LED array 26 is provided. Further, the proximity sensor 34 is arranged at the end of the light guide plate 21 at the same side as the infrared light LED 32 and close to the infrared light LED 32. In this embodiment, the infrared light LED 32 is formed integrally with the proximity sensor 34 to give a one-piece sensor 35. The three infrared light LEDs 31, 32, 32 are connected to the proximity sensor 34, while the proximity sensor 34 is connected to the CPU 37. The light emission from the infrared light LEDs 31, 32, and 33 is controlled by the proximity sensor 34 in this embodiment. Further, the light emission of the LED array 26 is performed by a signal from the CPU 37. The signal which is detected by the proximity sensor 34 is analyzed by the CPU 37. The light emission of the infrared light LEDs 31, 32, and 33 may also be performed by a signal from the CPU 37.

Note that, the infrared light LEDs 31 and 33 need not be arranged at the two ends of the LED array 26. As illustrated in FIG. 4B, they may also be arranged in the spaces of the backlight use LEDs 22 which form the LED array 26. In this case, the positions of the infrared light pass regions 36A, 36B which are provided at the infrared light shield plate 36 also change. The locations of provision of the infrared light pass regions 36A, 36B are predetermined locations in the direction of emission of infrared light from the infrared light LEDs 31, 33. By the provision of the infrared light LEDs 31, 33, when unevenness occurs in the illuminating light from the LED array 26, the luminances of the backlight use LEDs 22 near the infrared light LEDs 31, 33 are made higher than the luminances of the other backlight use LEDs 22 for adjustment.

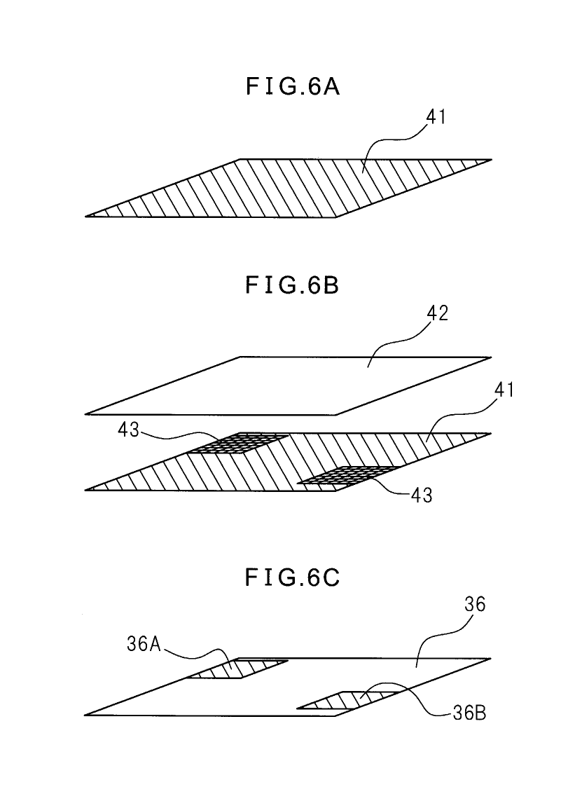

FIG. 6A to FIG. 6C illustrate a method of production of the infrared light shield plate 36 which is illustrated in FIG. 3. When producing the infrared light shield plate 36, as illustrated in FIG. 6A, an infrared light pass/visible light pass filter 41 of the same size as the light guide plate 21 is prepared. The infrared light pass/visible light pass filter 41 is a filter which passes infrared light and visible light. Next, as illustrated in FIG. 6B, at the infrared light pass/visible light pass filter 41, the regions where passage of infrared light is required are covered by masks 43. On this state of infrared light pass/visible light pass filter 41, an infrared light cut filter 42 is vapor deposited. As a result, it is possible to produce a filter such as illustrated in FIG. 6C which can completely pass visible light and which can pass infrared light only at the necessary regions 36A, 36B (parts covered by masks 43), that is, an infrared light shield plate 36.

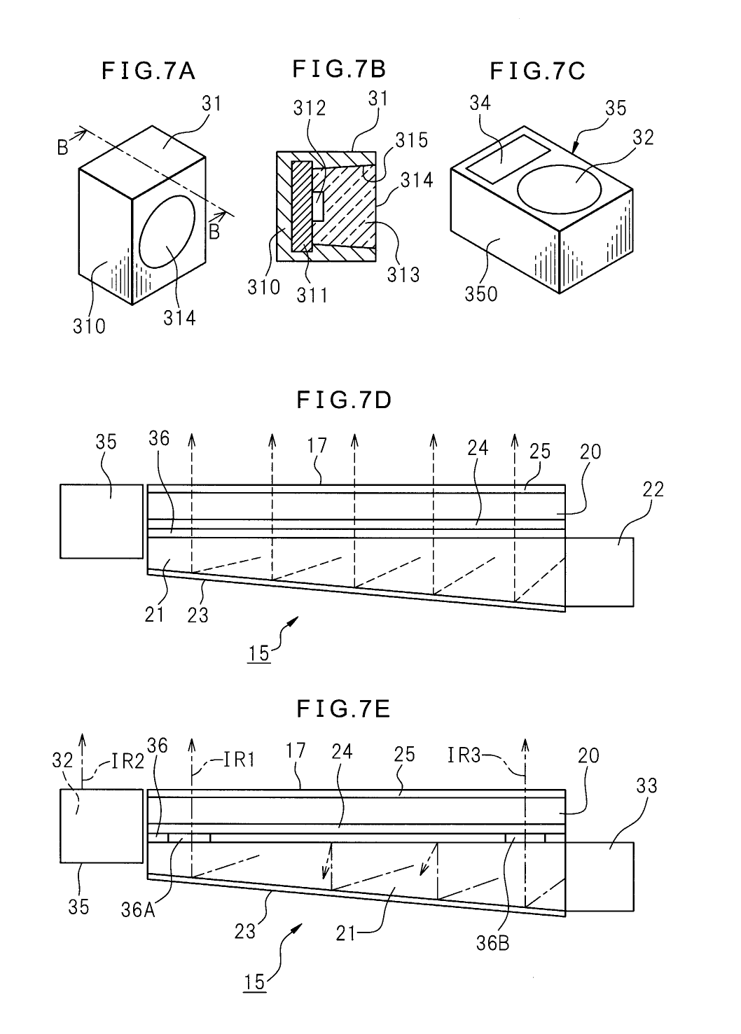

FIG. 7A is a perspective view which illustrates the appearance of an infrared light LED 31 which is used for the optical type object detector of the present application. The backlight use LEDs 22 and the infrared light LED 33 are configured in the same way as the infrared light LED 31, so here as a representative case, the infrared light LED 31 will be explained and the explanations of the backlight use LEDs 22 and infrared light LED 33 will be omitted. The infrared light LED 31 is provided with an infrared light emission aperture 314 at the side face of its body 310. Inside of the body 310, as illustrated by the longitudinal cross-sectional view in the line B-B of FIG. 7A, that is, FIG. 7B, there is a lead frame 311 on which electrodes are formed. An LED chip 312 is provided on the lead frame 311. A reflection layer 315 is formed at the inner circumferential surfaces of the space between the infrared light emission aperture 314 of the body 310 and the LED chip 312. The inside of the reflecting layer 315 is filled with a transparent resin 313.

FIG. 7C is a perspective view which illustrates the appearance of the one-piece sensor 35 which is used in the liquid crystal display device of the present application. The one-piece sensor 35 is comprised of a body 350 at which both an infrared light LED 32 and a proximity sensor 34 are provided. The proximity sensor 34 which is built into the one-piece sensor 35 has three channels of circuits for driving the infrared light LEDs and can make the infrared light LED 32 and the other two infrared light LEDs 31, 33 which are arranged near the one-piece sensor 35 emit light in a time division manner. Further, the proximity sensor 34 can analyze the phase difference of the received reflected light of infrared light from the infrared light LEDs 31 to 33 and obtain a grasp of the movement of the object reflecting the infrared light.

FIG. 7D is a cross-sectional view along the line D-D of FIG. 5A which illustrates the path of light emitted from the backlight use LEDs 22 in the liquid crystal display device of the present application. The backlight use LEDs 22 are mounted on a not illustrated circuit board. The light which is emitted from the backlight use LEDs 22 advances inside the light guide plate 21 while being reflected and is reflected upward and illuminates the liquid crystal panel 20 when striking the above-mentioned dot pattern.

FIG. 7E is a cross-sectional view along the line E-E of FIG. 5B which illustrates the path of light emitted from the infrared light LEDs 31 to 33 in the liquid crystal display device of the present application. The infrared light LEDs 31, 33 are attached to a not illustrated circuit board. The infrared light LED 32 is built into the one-piece sensor 35. The infrared light which is emitted from the infrared light LEDs 31, 33 advances inside the light guide plate 21 while being reflected and is reflected upward when striking the above-mentioned dot pattern, but almost all of the infrared light is blocked by the infrared light shield plate 36. On the other hand, among the infrared light which strikes the dot pattern and is reflected upward, the infrared light IR1, IR3 which reach the infrared light pass regions 36A, 36B pass through the infrared light shield plate 36 and pass through the liquid crystal panel 20 to be emitted upward from the display screen 17 of the liquid crystal display device 15. The infrared light IR2 which is emitted from the one-piece sensor 35 is emitted as it is upward from the liquid crystal display device 15.

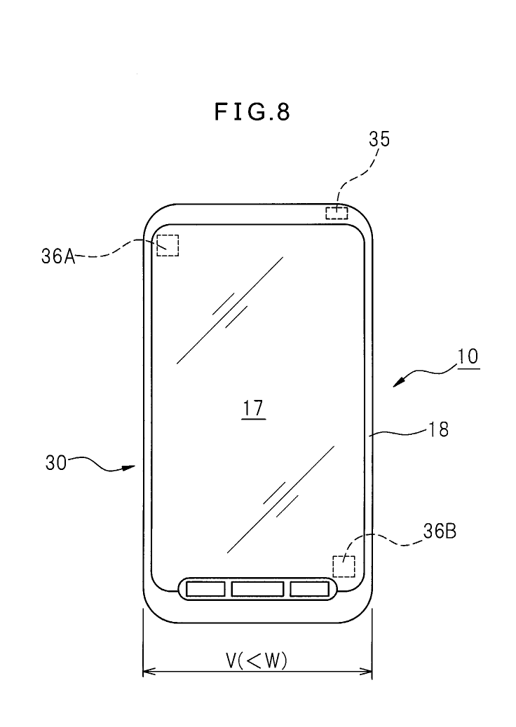

FIG. 8 is a plan view of an electronic device in which the optical type object detector is mounted in the present application, that is, a smartphone 10. One example of the arrangement of the infrared light pass regions 36A, 36B and one-piece sensor 35 on the display screen 17 is illustrated. The infrared light LED of the optical type object detector of the present application is not provided at the outside housing rim 18 in the long direction of the display screen 17 of the smartphone 10. For this reason, the housing width V of the smartphone 10 may be made smaller than the housing width W of the conventional electronic device 5 which is illustrated in FIG. 1. Alternatively, if making the size of the housing of the smartphone 10 no different from a conventional electronic device 5, the width of the housing rim 18 may be made smaller than the housing rim 7 of the conventional electronic device 5, so the liquid crystal display device may be made larger and a larger screen than a conventional electronic device 5 can be realized.

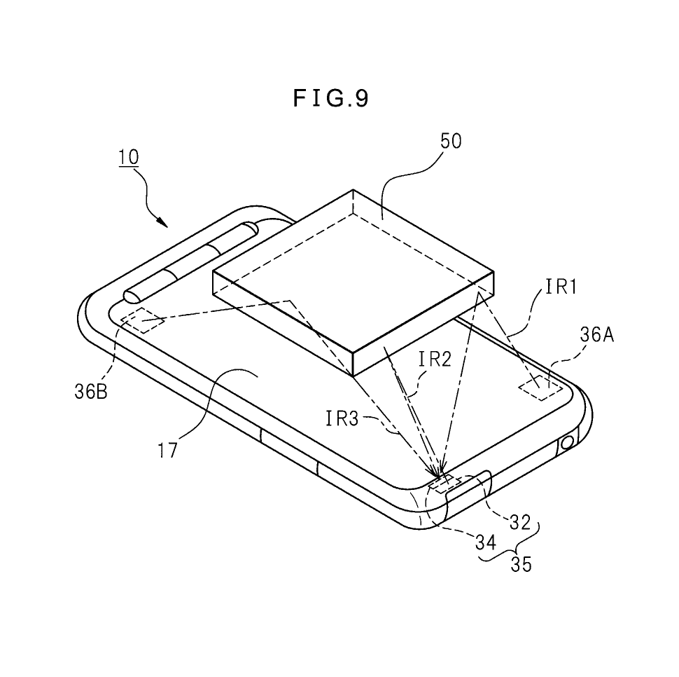

FIG. 9 is a perspective view which explains detection of a close object 50 in the smartphone 10 which is illustrated in FIG. 8. The infrared light IR1 which is emitted from the infrared light pass region 36A on display screen 17, the infrared light IR2 which is emitted from the one-piece sensor 35, and the infrared light IR3 which is emitted from the infrared light pass region 36B on the display screen 17 respectively are reflected at the close object 50 and enter the proximity sensor 34. As illustrated in FIG. 3, the signal which is detected from the proximity sensor 34 is sent to the CPU 37. The CPU 37 analyzes the phase difference of the reflected light of the infrared light IR1 to IR3 which are received at the proximity sensor 34, can obtain the position of the close object 50 reflecting the infrared light IR1 to IR3, and can detect movement of the close object 50 by the changes in the position captured. Further, the CPU 37 can use the results of detection of the direction of movement of the close object 50 to make the operation of the liquid crystal display device 15 stop. Note that the detected close object 50 is, for example, envisioned as being the human ear.

The range of detection of the object 50 by the optical type object detector of the present application is about 1 to 10 cm above the display screen 17. The results of detection of the direction of movement of the close object 50 may be used to scroll the touch panel, change the picture which is displayed on the display screen 17, turn the liquid crystal display device on or off, etc.

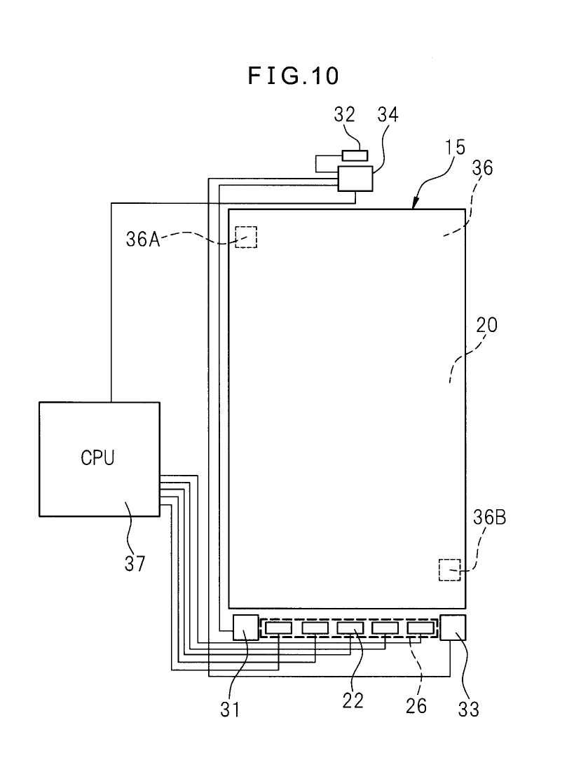

In the embodiment of the present application which was explained above, as illustrated in FIG. 4, the infrared light LED 32 is formed integrally with the proximity sensor 34 to give the one-piece sensor 35. However, an embodiment of a configuration where the infrared light LED 32 is not formed integrally with the proximity sensor 34 but is placed near the proximity sensor 34 is possible. FIG. 10 illustrates an optical type object detector of another embodiment of the present application. In the embodiment which is illustrated in FIG. 10, the infrared light LED 32 is not formed integrally with the proximity sensor 34, but is arranged near the proximity sensor 34. Other than the configuration of the infrared light LED 32 and proximity sensor 34 in this other embodiment, the configuration is the same as that explained in FIG. 4. The same members are assigned the same reference signs and further explanations are omitted.

Note that, according to the electronic device of the present embodiment, there is the effect that the housing of the electronic device does not becomes larger in size. According to the electronic device of the present embodiment, by making the direction of light emission of the infrared light LEDs the same as the direction of light emission of the backlight source of the liquid crystal display, there is no need to provide a special light emission window in the housing of the electronic device, so the design property can be improved. According to the electronic device of the present embodiment, by utilizing the light guide plate and deflection plate of the liquid crystal display so as to make the light emitted from the infrared light LEDs a direction above the display, there is the effect that the freedom of arrangement of the infrared light LEDs increases. According to the electronic device of the present embodiment, there is the effect that it is possible to increase the size of the display screen compared with the size of the housing of the electronic device.

Although only some exemplary embodiments of this invention have been described in detail above, those skilled in the art will readily appreciated that many modifications are possible in the exemplary embodiments without materially departing from the novel teachings and advantages of this invention. Accordingly, all such modifications are intended to be included within the scope of this invention.

What is claimed is:

1. An electronic device which is provided with a liquid crystal display device having a light source, a light guide plate, and a liquid crystal panel and which optically detects proximity of an object to said liquid crystal display device,
said electronic device provided with
at least one infrared light emitting device which is arranged along an end of said light guide plate aligned with said light source and from which infrared light is emitted from a display screen of said liquid crystal display device,
an infrared light shield plate which is interposed between said light guide plate and said liquid crystal display panel and which is provided with infrared light pass regions which pass infrared light which are emitted from said at least one infrared light emitting device,
an infrared light emitting device which is arranged at a position separated from said infrared light pass regions and which emits infrared light in a direction vertical to said display screen,
a proximity sensor which detects light of infrared light reflected by said object, and
a control device which detects proximity of said object to said display screen by a detection signal of reflected light of the infrared light from said proximity sensor.

2. An electronic device as set forth in claim 1, wherein the infrared light emitting devices which are arranged aligned with said light source include a first and second, that is, two, infrared light emitting devices, an infrared light emitting device which is arranged separated from said infrared light pass regions is a third infrared light emitting device, and said proximity sensor detects reflection of the three infrared lights.

3. An electronic device as set forth in claim 1, wherein said light source is comprised of a light emitting diode and the infrared light emitting devices which are arranged aligned with said light emitting diode are used to adjust the luminance of said light emitting diode when unevenness of luminance occurs in the liquid crystal panel which is illuminated through the light guide plate.

4. An electronic device as set forth in claim 2, wherein said light source is comprised of a light emitting diode and the infrared light emitting devices which are arranged aligned with said light emitting diode are used to adjust the luminance of said light emitting diode when unevenness of luminance occurs in the liquid crystal panel which is illuminated through the light guide plate.

5. An electronic device as set forth in claim 1, wherein said proximity sensor and said infrared light emitting device are comprised of a mixed sensor in which they are integrally formed.

6. An electronic device as set forth in claim 1, wherein said light source is comprised of a light emitting diode array, and said infrared light emitting devices are infrared light emitting diodes which are arranged at the outside of the two ends of said light emitting diode array or in spaces between the light emitting diodes which form said light emitting diode array.

7. An electronic device as set forth in claim 4, wherein said light source is comprised of a light emitting diode array, and said infrared light emitting devices are infrared light emitting diodes which are arranged at the outside of the two ends of said light emitting diode array or in spaces between the light emitting diodes which form said light emitting diode array.

8. An electronic device as set forth in claim 1, wherein the infrared light emitting devices which are arranged near either side face of said liquid crystal display device differ in distance from said infrared light pass regions.

9. An electronic device as set forth in claim 5, wherein the infrared light emitting devices which are arranged near either side face of said liquid crystal display device differ in distance from said infrared light pass regions.

10. A method of production of an infrared light shield plate mounted in an electronic device comprising
preparing a first pass filter which passes infrared light and visible light and
masking regions through which infrared light passes in the first pass filter, and
vapor depositing a second filter which blocks the passage of infrared light through the first pass filter.
